(19) United States
(12) Patent Application Publication
(10) Pub. No.: US 2007/0221047 A1
(43) Pub. Date: Sep. 27, 2007

(54) Method and apparatus for assigning tone for display object, and computer-readable medium having embodied hereon computer program for executing method thereof

(75) Inventor: Young-sun Kim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/603,154

(22) Filed: Nov. 22, 2006

(30) Foreign Application Priority Data
Mar. 8, 2006 (KR) 10-2006-0021842

(51) Int. Cl. G10H 1/00; G10H 1/18; G10H 7/00

(52) U.S. Cl. 84/615

(57) ABSTRACT

A method and apparatus for assigning a tone for an object displayed in a mobile device or a digital convergence product having a display function are provided. The method includes displaying a screen in which a staff and at least one musical note are assigned to each of a plurality of display objects on the screen; and if a display object of the plurality of display objects is selected from the screen and tone modification is requested, modifying the tone of the selected object, so that the modified tone is assigned to a musical note of the selected display object.

### CROSS REFERENCE TO RELATED PATENT APPLICATION

This application claims priority from Korean Patent Application No. 10-2006-0021842, filed on Mar. 8, 2006, in the Korean Intellectual Property Office, the disclosure of which is incorporated herein in its entirety by reference.

### BACKGROUND OF THE INVENTION

1. Field of the Invention

Methods and apparatuses consistent with the present invention relate to assigning a tone for a display object and more particularly, to assigning a tone for an object displayed in a mobile device or a digital convergence product having a display function.

2. Description of the Related Art

Recently, as more electronic devices have multiple functions, there is a growing demand for mobile devices and digital convergence products which can be customized to satisfy various preferences of individual users. To meet this demand, a method has been proposed in which a sound effect selected by a user can be assigned for a bell sound of a mobile device. In addition, a method of playing music by using a key pad of a mobile device also has been proposed. However, a method, in which the user can assign a tone for a display object, has yet been proposed. The display object may be an item of a menu screen.

### SUMMARY OF THE INVENTION

Exemplary embodiments of the present invention overcome the above disadvantages and other disadvantages not described above. Also, the present invention is not required to overcome the disadvantages described above, and an exemplary embodiment of the present invention may not overcome any of the problems described above.

The present invention provides a method and apparatus for assigning a tone for an object displayed in a mobile device or a digital convergence product having a display function, and a computer-readable medium having embodied thereon a computer program for executing the method thereof.

The present invention also provides a method and apparatus for assigning a tone for a menu item displayed in a mobile device or a digital convergence product having a display function, and a computer-readable medium having embodied thereon a computer program for executing the method thereof.

According to an aspect of the present invention, there is provided a method of assigning a tone for a display object, including displaying a screen in which a staff and at least one musical note are assigned to each of display objects; and modifying the tone of the selected object, if one object is selected from the display screen and tone modification is requested so that the modified tone is assigned to a musical note of the selected object.

According to the aforementioned aspect of the present invention, the method may further include outputting an audio signal corresponding to the tone of the musical note assigned to the selected object whenever one object is selected from the displayed screen.

In addition, the object may be selected by pressing left/right buttons included in an apparatus for displaying the screen, and the tone may be modified by pressing up/down buttons included in the apparatus for displaying the screen.

According to another aspect of the present invention, there is provided an apparatus for assigning a tone for a display object, including a storage unit that stores a staff and at least one musical note for each of display objects; a display unit which displays a screen in which the staff and the at least one musical note are assigned to each of the display objects; an instruction input unit which inputs a user instruction; an audio output unit which outputs an audio signal; and a control unit which selects one object from the screen according to an instruction input from the instruction input unit, and assigns a tone for the selected object.

According to another aspect of the present invention, there is provided a computer-readable medium having embodied thereon a computer program for executing a method of assigning a tone for a display object, the computer-readable medium including a code which displays a screen in which a staff and at least one musical note is assigned to each of display objects; and a code modifying the tone of the selected object, if one object is selected from the display screen and tone modification is requested so that the modified tone is assigned to a musical note of the selected object.

### BRIEF DESCRIPTION OF THE DRAWINGS

The above and other aspects of the present invention will become more apparent by describing in detail exemplary embodiments thereof with reference to the attached drawings in which:

FIG. 1 is a block diagram of an apparatus for assigning a tone for a display object according to an exemplary embodiment of the present invention;

FIG. 2 illustrates an example of a tone assignment for a display object according to an exemplary embodiment of the present invention;

FIG. 3 is a flowchart of a method of assigning a tone for a display object according to an exemplary embodiment of the present invention;

FIG. 4 is a flowchart of a method of assigning a tone for a display object according to another exemplary embodiment of the present invention; and

FIG. 5 is a flowchart of a method of assigning a tone for a display object according to another exemplary embodiment of the present invention.

### DETAILED DESCRIPTION OF THE EXEMPLARY EMBODIMENTS OF THE INVENTION

Hereinafter, the present invention will be described in detail by explaining exemplary embodiments of the invention with reference to the attached drawings.

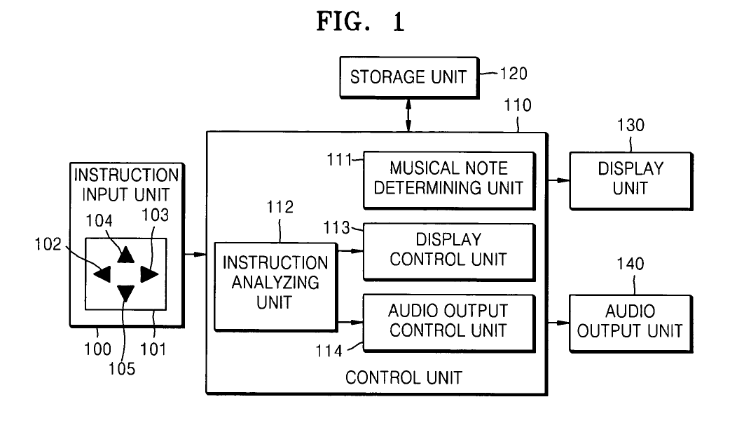

FIG. 1 is a block diagram of an apparatus for assigning a tone for a display object according to an exemplary embodiment of the present invention. The apparatus of FIG. 1 is included in a mobile device or a digital convergence product. Referring to FIG. 1, the apparatus includes an instruction input unit 100, a control unit 110, a storage unit 120, a display unit 130, and an audio output unit 140.

A user instruction is input through the instruction input unit 100. Examples of instructions input to the instruction input unit 100 include an instruction for assigning a tone for an object displayed on the display unit 130, and an instruction for fast scrolling objects displayed on the display unit 130. The instruction for assigning a tone may include an instruction for selecting an object which is displayed on the display unit 130 for tone assignment, and an instruction for modifying a tone to be assigned to the selected object. The instruction for fast scrolling the objects displayed on the display unit 130 may use the same instruction for selecting the above object.

The instruction input unit 100 includes four-direction button portion 101. The four-direction button portion 101 includes left and right buttons 102 and 103 and up and down buttons 104 and 105. The left and right buttons 102 and 103 select an object displayed on the display unit 130 for tone assignment.

For example, when the left button 102 is pressed one time, a currently selected object from objects displayed on the display unit 130 is positioned on the left side of a previously selected object. On the other hand, when the right button 103 is pressed one time, a currently selected object from objects displayed the display unit 130 is positioned on the right side of a previously selected object. Accordingly, the instruction for selecting a single object from objects displayed on the display unit 130 and the instruction for fast scrolling the display objects may be input by pressing the left and right buttons 102 and 103.

That is, whenever the left button 102 is pressed, the currently selected object from the objects displayed on the display unit 130 moves to the left. On the other hand, whenever the right button 103 is pressed, the currently selected object from the objects displayed on the display unit 130 moves to the right. When the left button 102 is continuously pressed, the objects displayed on the display unit 130 are scrolled fast to the left. On the other hand, when the right button 103 is continuously pressed, the objects displayed on the display unit 130 are scrolled fast to the right.

Whenever the up button 104 is pressed one time, a tone of the currently selected object becomes higher by one tone. On the other hand, whenever the down button 105 is pressed one time, the tone of the currently selected object becomes lower by one tone. Accordingly, the instruction for modifying a tone may be input by pressing the up and down buttons 104 and 105.

According to an instruction that is input from the instruction input unit 100, the control unit 110 selects one of the objects displayed on the display unit 130, and assigns a tone for a musical note of the selected object.

Specifically, if the objects displayed on the display unit 130 are menu items such as video, music, or photo, and a menu screen including the menu items is displayed on the display unit 130, then the control unit 110 firstly determines a musical note for each menu item based on content capacity assigned to each menu item stored in the storage unit 120.

That is, after checking the content capacity assigned to each menu item, the control unit 110 assigns a musical note indicating long duration of a musical sound to a musical note of a menu item having a big content capacity, and assigns a musical note indicating short duration of a musical sound to a musical note of a menu item having a small content capacity.

For example, if a whole note, a half note, a quarter note, an eighth note, a sixteenth note, and a thirty second tone are available to be assigned, the control unit 110 may assign the whole note to a musical note of a menu item having the largest storage capacity, and assign the thirty second note to a musical note of a menu item having the smallest storage capacity. The control unit 110 determines whether each menu storage capacity is large or small based on a reference value. The reference value may be defined by a user.

The control unit 110 stores a staff and a musical note assigned for a display object in the storage unit 120. When requesting a display of the display object from the instruction input unit 100, the control unit 110 reads the staff and the musical note from the storage unit 120, and allows the display unit 130 to display a screen in which the staff and the musical note are assigned by each of the display object. In this case, a tone of the displayed musical note may be a default tone, or a tone defined by the user.

When the left and right buttons 102 and 103 of the instruction input unit 100 are pressed in a state that the above screen is displayed on the display unit 130, the control unit 110 recognizes that an object displayed on the display unit 130 is requested to be selected. In addition, when the up and down buttons 104 and 105 of the instruction input unit 100 are pressed in this state, the control unit 110 recognizes that tone modification is requested so that the modified tone is assigned to a currently selected object from the objects displayed on the display unit 130.

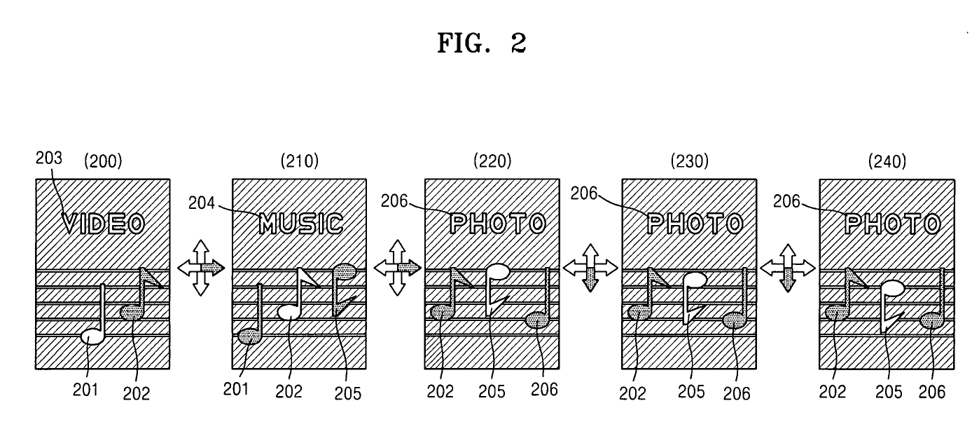

FIG. 2 illustrates an example of a tone assignment for a display object according to an exemplary embodiment of the present invention. The operation of the tone assignment performed by the control unit 110 will now be described with reference to FIG. 2. If the right button 103 is pressed when a screen 200, in which a video menu item is selected as a menu item currently selected (current object), is displayed on the display unit 130, the control unit 110 allows the display unit 130 to display a screen 210 in which the video menu item is modified into a music menu item located in the right side of the video menu item. The screen 210 of FIG. 2 includes a musical note 201 of a previously selected object (menu item), a musical note 202 of a currently selected object, and a musical note 205 of an object to be selected next when the right button 103 is pressed.

Thereafter, when the right button 103 is pressed again, the control unit 110 allows the display unit 130 to display a screen 220 in which the currently selected menu item is modified into a photo menu item located in the right side of the music menu. In this state, when the down key 105 is pressed, the control unit 10 allows the display unit 130 to display a screen 230 in which the musical note 205 of the photo menu item is lowered by one tone. Thereafter, when the down key 105 is pressed again, the control unit 110 allows the display unit 130 to display a screen 240 in which the musical note 205 of the photo menu item is lowered again by one tone.

Whenever a single object is selected from the objects displayed on the display unit 130, the control unit 110 may output an audio signal, which corresponds to a tone of a musical note assigned to the selected object, to the audio output unit 140. For example, when the video menu item is selected as shown in the screen 200, the control unit 110 may output the audio signal, which corresponds to a tone of a musical note assigned to the video menu item, to the audio output unit 140. Thereafter, as shown in screen 210, when a currently selected object is modified from the video menu item to the music menu item, the control unit 110 may output an audio signal, which corresponds to a tone of a musical note assigned to the music menu item, to the audio output unit 140.

As shown in FIG. 2, whenever an object displayed on the display unit 130 is selected, the control unit 110 may allow the display unit 130 to display an object name (a video 203, a music 204, or a photo 206 of FIG. 2) of the selected object and to highlight the musical notes 201, 202, and 205 of the selected object.

To perform the above mentioned operations, the control unit 110 may include a musical note determining unit 111, an instruction analyzing unit 112, a display control unit 113, and an audio output control unit 114.

The musical note determining unit 111 decides whether content capacity of each of the objects displayed on the display unit 130 is large or small by using the aforementioned reference value, and determines a musical note corresponding to each of the objects.

The instruction analyzing unit 112 analyzes whether an instruction input from the instruction input unit 106 indicates that an object displayed in the display unit 130 has to be selected, or indicates that a tone has to be modified so as to be assigned to the selected object.

The display control unit 113 allows the display unit 130 to display a screen in which a staff and at least one musical note are assigned for each of display objects, to highlight a musical note and an object name of an object selected according to an instruction sent from the instruction analyzing unit 112, and to display a tone modified at the request thereof.

The audio output control unit 114 controls the audio output unit 140 to output a tone of a musical note assigned to a selected object, and an audio signal corresponding to a tone modified at the request thereof. In a fast scrolling operation for display objects, an object is selected fast. Thus, when a display object is selected fast, the audio output control unit 114 controls the audio output unit 140 to continuously output an audio signal corresponding to a tone of the selected object. That is, when the left button 102 or the right button 103 is continuously pressed, the audio output control unit 114 controls the audio output unit 140 so that an audio signal corresponding to a tone assigned for each object is continuously output while objects displayed on the display unit 130 are fast scrolled. Then, a jingle sound of the object displayed on the display unit 130 is generated.

The storage unit 120 stores a staff and at least one musical note for each of the display objects. Furthermore, the storage unit 120 stores information on content capacity for each of the display objects. When a tone for each of the display objects is determined, the control unit 110 uses information on content capacity for each of the display object stored in the storage unit 120.

The display unit 130 is controlled by the control unit 110, and displays a screen in which a staff and at least one musical note for each of the display objects are assigned. In particular, in order to distinguish a selected object from non-selected objects, a musical note of the selected object is highlighted, and an object name of the selected object is displayed. Whenever a tone of the selected object is modified, the modified tone is displayed. A musical note displayed on the display unit 130 is dependant on content capacity of a corresponding object. Thus, the user may assume the content capacity of the corresponding object based on the musical note displayed on the display unit 130. The display unit 130 may have a user interface (UI) function.

The audio output unit 140 outputs an audio signal corresponding to a tone of a music note of an object selected from objects displayed under the control of the control unit 110. Accordingly, the user can assume content capacity of each object based on duration of an audio signal output through the audio output unit 140. In addition, the user can recognize an object having a high priority and its distribution based on a tone of the audio signal output through the audio output unit 140.

That is, in order to recognize a priority based on a tone of the audio signal output through the audio output unit 140, the user may assign a tone of a musical note of a display object having a high priority to a high tone (for example, “la”), and assign a tone of a musical note of a display object having a low priority to a low tone (for example, “re”). In this case, the user can easily recognize a priority of a display object and its distribution based on the tone of the audio signal output through the audio output unit 140.

When the tone of the selected object is modified, an audio signal corresponding to the modified tone is output. Thus, the user can assign a desired tone according to his or her preference. Accordingly, the user can create a jingle sound of the object displayed on the display unit 130.

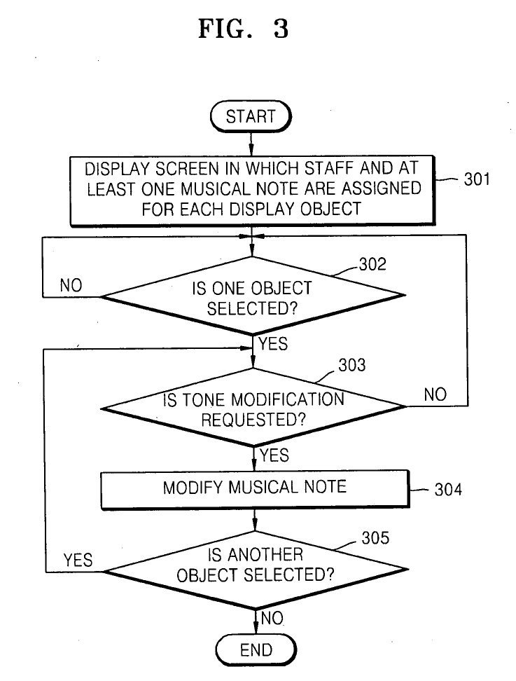

FIG. 3 is a flowchart of a method of assigning a tone for a display object according to an exemplary embodiment of the present invention. The operation of FIG. 3 will now be described in detail with reference to FIG. 1.

First, the control unit 110 allows the display unit 130 to display a screen in which a staff and at least one music note are assigned for each object displayed on the display unit 130 (operation 301). This is performed at the request of the user as described above with reference to FIG. 1. As described in FIG. 1, the music note assigned for each object is determined according to content capacity for each object. Here, a tone of the displayed musical note may be a default tone, or a predetermined tone defined by the user.

The control unit 110 modifies a tone of the selected object, when a single object is selected from objects displayed on the display unit 130, and a modification of a time of the selected object is requested according to an instruction input from the instruction input unit 100 (operations 302, 303, and 304). As a result, the musical note of the selected object displayed on the display unit 130 is updated to indicate that the modified tone is assigned to the musical note of the selected object. Thereafter, the modified tone of the selected object is output to the audio output unit 140. In this case, the instruction for selecting an object may be input by pressing the left/right buttons 102 and 103 of FIG. 1, and the instruction for requesting tone modification may be input by pressing the up/down buttons 104 and 105 of FIG. 1.

If the instruction input unit 100 requests to select another object, the control unit 110 repeats the aforementioned operations, returning to operation 303. Otherwise, the control unit 110 ends the operation for tone assignment (operation 305).

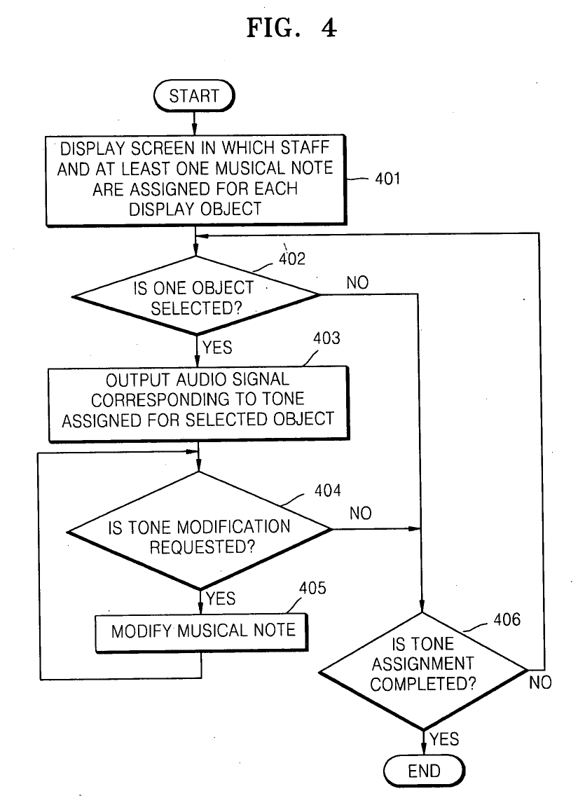

FIG. 4 is a flowchart of a method of assigning a tone for a display object according to another exemplary embodiment of the present invention. In comparison with FIG. 3, a function for outputting an audio signal corresponding to a tone assigned for a selected object whenever one object is selected from a displayed screen is further shown in FIG. 4.

First, like operation 301 of FIG. 3, a screen in which a staff and at least one musical note are assigned for each object displayed on the display unit 130 is displayed (operation 401). Thereafter, when one object is selected from the screen displayed on the display unit 130 according to an instruction input from the instruction input unit 100, the control unit 110 outputs an audio signal corresponding to a tone of a musical note assigned for the selected object to the audio output unit 140 (operations 402 and 403). The instruction for selecting an object may be input by pressing the left/right buttons 102 and 103 of FIG. 1. The musical note for each object is determined based on content capacity for each object as described in FIG. 1. In this case, a tone of the displayed musical note may be a default tone, or a tone defined by the user.

When tone modification is requested so that the modified tone is assigned to a musical note of the selected object, the control unit 110 modifies the tone (operations 404 and 405), and then the process returns to operation 404. Here, the request for tone modification may be input by pressing the up/down buttons 104 and 105 of FIG. 1.

If there is no object selected in operation 402, or the tone modification is not requested in operation 404, the control unit 110 checks whether the operation for tone assignment is completed (operation 406). If the check result indicates that the operation for tone assignment is not completed, the control unit 110 repeats the aforementioned operations, returning to operation 402. Otherwise, the control unit 110 ends the operation for tone assignment.

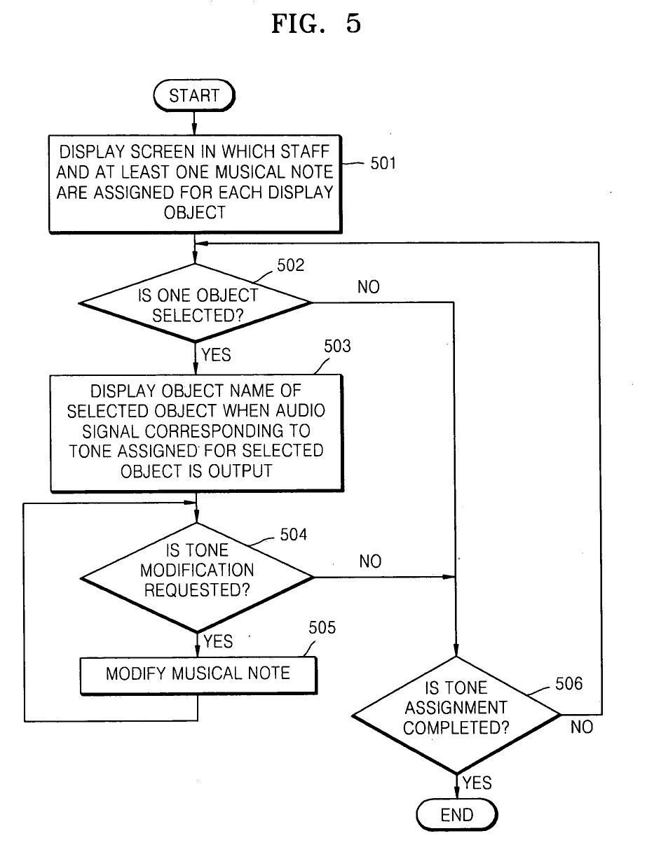

FIG. 5 is a flowchart of a method of assigning a tone for a display object according to another exemplary embodiment of the present invention. In comparison with FIG. 4, a function for displaying an object name of a selected object when an audio signal corresponding to a tone assigned for a selected object is output, whenever one object is selected from a displayed screen is further shown in FIG. 5.

First, like operation 401 of FIG. 4, a screen in which a staff and at least one musical note are assigned for each object displayed on the display unit 130 is displayed (operation 501). Thereafter, when one object is selected from the screen displayed on the display unit 130 according to an instruction input from the instruction input unit 100, the control unit 110 outputs an audio signal corresponding to a tone of a musical note assigned for the selected object to the audio output unit 140 (operations 502 and 503).

In this process, the control unit 110 allows the display unit 130 to display an object name of the selected object. The display object name is the same as shown in FIG. 2. When the object name of the selected object is displayed, the control unit 110 may highlight a musical note assigned for the selected object as described in FIGS. 1 and 2. The instruction for selecting an object may be input by pressing the left/right buttons 102 and 103 of FIG. 1. The musical note for each object is determined based on content capacity for each object as described in FIG. 1. In this case, a tone of the displayed musical note may be a default tone, or a tone defined by the user.

When tone modification is requested so that the modified tone is assigned to a musical note of the selected object, the control unit 110 modifies the tone (operations 504 and 505), and then the process returns to operation 504. Here, the request for tone modification may be input by pressing the up/down buttons 104 and 105 of FIG. 1.

If there is no object selected in operation 502, or the tone modification is not requested in operation 504, the control unit 110 checks whether the operation for tone assignment is completed (operation 5406). If the check result indicates that the operation for tone assignment is not completed, the control unit 110 repeats the aforementioned operations, returning to operation 502. Otherwise, the control unit 110 ends the operation for tone assignment.

According to exemplary embodiments of the present invention, a user can assign a tone of an object (for example, a menu item) displayed in a mobile device or a digital convergence product, so that a jingle sound assigned by the user can be output when display objects are scrolled fast.

In addition, a tone of a display object can be assigned by taking the user's preference into account. Therefore, an object having a high priority can be easily recognized from display objects based on the tone, and an object distribution can be easily obtained based on priority.

Furthermore, content capacity of the display object can be assumed based on a displayed musical note and duration of a musical sound of a played tone.

The invention can also be exemplarily embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of assigning a tone for a display object, the method comprising:
displaying a screen in which a staff and at least one musical note are assigned to each of a plurality of display objects on the screen; and
if a display object of the plurality of display objects is selected from the screen and tone modification is requested, modifying the tone of the selected display object, so that the modified tone is assigned to a musical note assigned to the selected display object.

2. The method of claim 1, further comprising outputting an audio signal, which corresponds to the tone of the musical note assigned to the selected display object, if the display object is selected from the screen.

3. The method of claim 2, further comprising displaying an object name of the selected display object if the display object is selected.

4. The method of claim 3, further comprising highlighting the musical note assigned to the selected display object displayed on the screen.

5. The method of claim 4, wherein the display object of the plurality of display objects is selected in response to pressing a left button or a right button of an apparatus for displaying the screen, and the tone is modified in response to pressing an up button or a down button of the apparatus for displaying the screen.

6. The method of claim 3, wherein the musical note is determined based on content capacity of a corresponding display object.

7. The method of claim 2, wherein the musical note is determined based on content capacity of a corresponding display object.

8. The method of claim 2, wherein the display object of the plurality of display objects is selected by pressing a left button or a right button of an apparatus for displaying the screen, and the tone is modified by pressing an up button or a down button of the apparatus for displaying the screen.

9. The method of claim 1, wherein the displayed screen is a menu screen, and the display object is a menu item.

10. An apparatus for assigning a tone for a display object, the apparatus comprising:
a storage unit which stores a staff and at least one musical note for each of a plurality of display objects;
a display unit which displays a screen in which the staff and the at least one musical note are assigned to each of the plurality of display objects;
an instruction input unit which inputs a user instruction;
an audio output unit which outputs an audio signal; and
a control unit which selects a display object of the plurality of display objects from the screen according to an instruction input from the instruction input unit, and assigns a tone to the selected display object.

11. The apparatus of claim 10, wherein the control unit outputs an audio signal corresponding to a tone of the musical note assigned to the selected display object if the display object of the plurality of display objects is selected from the screen.

12. The apparatus of claim 11, wherein the control unit displays an object name of the selected display object if the display object is selected.

13. The apparatus of claim 12, wherein the screen displayed on the display unit is a menu screen, and the display object is a menu item.

14. The apparatus of claim 13, wherein the control unit determines a tone for each of the plurality of display objects stored in the storage unit according to content capacity of each of the plurality of display objects.

15. The apparatus of claim 13,
wherein the instruction input unit comprises a left button, a right button, an up button and a down button,
wherein, if the left button or the right button is pressed, the control unit recognizes that selection of one of the plurality of display objects is requested, and if the up button or the down button is pressed, the control unit recognizes that tone modification is requested so that the modified tone is assigned to the selected display object, and
wherein, the control unit controls the display unit so that the musical note having the modified tone is displayed while an audio signal corresponding to the modified tone is output to the audio output unit, if the tone of the selected display object is modified.

16. The apparatus of claim 10,
wherein the instruction input unit comprises a left button, a right button, an up button and a down button,
wherein, if the left button or the right button is pressed, the control unit recognizes that selection of one of the plurality of display objects is requested, and if the up button or the down button is pressed, the control unit recognizes that tone modification is requested so that the modified tone is assigned to the selected display object, and
wherein, the control unit controls the display unit so that the musical note having the modified tone is displayed while an audio signal corresponding to the modified tone is output to the audio output unit, whenever the tone of the selected display object is modified.

17. A computer-readable medium having embodied thereon a computer program for executing a method of assigning a tone for a display object, the method comprising:
displaying a screen in which a staff and at least one musical note assigned to each of a plurality of display objects on the screen; and
if a display object of a plurality of display objects is selected from the screen and tone modification is requested, modifying the tone of the selected object, so that the modified tone is assigned to a musical note assigned to the selected display object.

18. The computer-readable medium of claim 17, wherein the method further comprises a code outputting an audio signal, which corresponds to the tone of the musical note assigned to the selected display object, if a display object is selected from the screen.
